(19) United States
(12) Patent Application Publication
(10) Pub. No.: US 2006/0239682 A1
(43) Pub. Date: Oct. 26, 2006

(54) Time and wavelength division multiplexed passive optical network

(75) Inventors: Keun-joo Park, Yongin-si (KR); Hyun-chin Kim, Seongnam-si (KR); Young-kwang Seo, Seoul (KR); Yeong-bae Yeo, Daegu (KR); June-koo Rhee, Seongnam-si (KR); Chun-ju Youn, Yongin-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/357,172

(22) Filed: Feb. 21, 2006

(30) Foreign Application Priority Data
Apr. 21, 2005 (KR) 2005-0033314

(51) Int. Cl. H04J 14/00

(52) U.S. Cl. 398/71

(57) ABSTRACT

A time and wavelength division multiplexed passive optical network where a central office has a downstream transmitter and an upstream receiver. The downstream transmitter multiplexes and transmits downstream optical signals in a time region. The upstream receiver de-multiplexes, in a wavelength region, an upstream optical signal. An optical network unit has a downstream receiver and an upstream transmitter, where the downstream receiver de-multiplexes, in the time region, the downstream optical signals from the central office. The upstream transmitter multiplexes the upstream optical signal in the wavelength region and transmits the signal to the central office. A remote node, having an optical distributor and a wavelength division multiplexer, is connected between the central office and the optical network unit. The optical distributor distributes the downstream optical signals from the central office. The wavelength division multiplexer multiplexes, in the wavelength region, the upstream optical signal from each optical network unit.

### CROSS-REFERENCE TO RELATED APPLICATIONS

This application claims benefit under 35 U.S.C. § 119 from Korean Patent Application No. 2005-0033314, filed on Apr. 21, 2005, the entire content of which is incorporated herein by reference.

### BACKGROUND OF THE INVENTION

1. Field of the Invention

The present invention relates to a time and wavelength division multiplexed passive optical network, and more particularly, to a time and wavelength division multiplexed passive optical network to transmit optical signals of good quality.

2. Description of the Related Art

A radical increase in the demand for bandwidth multimedia including the Internet has required a fiber to the home (FTTH) network in which an optical fiber system is installed in each home, and a passive optical network (PON) has been suggested accordingly. The PON is the communication net system for transferring signals to a final user through the optical cable net. The PON is a point to multipoint net structure in which a number of optical network units (ONU) share an optical line termination (OLT) through one optical fiber and, in general, a maximum of thirty-two ONUs can be connected to one OLT.

In a single system, the PON is capable of providing a bandwidth of 622 Mbps downstream and 155 Mbps upstream to a user, and this bandwidth can be assigned to a number of users of the PON. In addition, the PON can be used as a trunk between a large-sized system such as a cable TV system and an Ethernet network for a nearby building or a home using a coaxial cable.

The PON can be classified as a wavelength-division-multiplexed passive optical network (hereinafter, referred to as “WDM PON”) and an Ethernet PON (hereinafter, “EPON”) according to the transmission modes for exchanging information with subscribers.

The WDM PON provides a very high-speed broadband communication service by using intrinsic wavelength assigned to each subscriber. Thus, it is possible to secure confidential communications, to easily receive an additional communication service or an increased capacity which each subscriber requests, and to easily increase the number of subscribers by adding the intrinsic wavelength assigned to a new subscriber.

FIG. 2 is a constitutional block diagram of a general WDM PON, in which a central office 10 comprises a number of transmitters (Tx) 11-1, . . . , 11-N for transmitting a number of optical wavelength signals and transmits the signals to an ONU 30.

A waveguide grating router 20 mechanically distributes the wavelengths as being determined in the ONU 30. Thus, a number of transmitters (Tx) 11-1, . . . , 11-N and a number of receivers (Rx) 13-1, . . . , 13-N are arranged in the central office 10.

The EPON has a structure in that the central office is connected to the subscriber in a tree structure, and it can constitute an effective network at a more inexpensive price, compared to the WDM PON. The connection structure between the central office and subscribers is 1 to N.

FIG. 1 is a constitutional block diagram of a general EPON. The general EPON comprises one OLT 110 and a number of ONU 130-1, . . . , 130-N, wherein the OLT 110 and ONU 130-1, . . . , 130-N are connected by a splitter 120. The OLT 110 is positioned in a route with the tree structure and performs a main function to provide information to each subscriber of the access net.

The splitter 120 is connected to the OLT 110. The splitter 120 has a tree topological structure to distribute a downstream data frame which is transmitted from the OLT 110 to the number of ONU, for example, which are N, 130-1, . . . , 130-N and, also, to multiplex an upstream data frame from the ONU 110 by a time division multiplex (TDM) system and to transmit the multiplexed data frame to the OLT 110.

Both of the WDM PON and the EPON have their respective merits. Nevertheless, there are problems in that the costs are expensive or the defects of each system occur if only one system is used.

### SUMMARY OF THE INVENTION

Accordingly, it is an aspect of the present invention to provide a time and wavelength division multiplexed passive optical network, in which a time-division-multiplex system is selected in downstream transmitting data and a wavelength division multiplex system is selected in upstream transmitting the data.

The above aspect of the present invention is substantially realized by providing a time and wavelength division multiplexed passive optical network which includes a central office having a downstream transmitter and at least one upstream receiver, wherein the downstream transmitter multiplexes downstream optical signals in a time region and transmits the multiplexed signals, and at least one upstream receiver de-multiplexes, in a wavelength region, at least one upstream optical signal which is multiplexed in the wavelength region and is transmitted and receives the de-multiplexed signal; an optical network unit (ONU) having a downstream receiver and an upstream transmitter, wherein the downstream receiver de-multiplexes, in the time region, the downstream optical signals which are multiplexed in the time region and transmitted from the central office and receives the de-multiplexed signals, and the upstream transmitter multiplexes the upstream optical signal in the wavelength region and transmits the multiplexed signal to the central office; and a remote node having an optical distributor and a wavelength division multiplexer, wherein the remote node is connected between the central office and the optical network unit, the optical distributor distributes the downstream optical signals, which are multiplexed in the time region and transmitted from the time, region of the central office, to each optical network unit, and the wavelength division multiplexer multiplexes the upstream optical signal, which is transmitted from each optical network unit, in the wavelength region.

The wavelength division multiplexer may include a first router for multiplexing, in a wavelength band, each optical signal as being transmitted from at least one optical network unit.

The central office may include a second router for de-multiplexing, in the wavelength region, the upstream optical signal as being transmitted from the optical network unit.

The downstream optical signal operates in a wavelength band of 1.3 μm.

The upstream optical signal operates in a wavelength band of 1.5 μm.

The optical distributor may have a band passing filter for passing wavelength of light as being transmitted from the downstream transmitter, by limiting the wavelength to a predetermined band.

The central office may have a band passing filter for passing the wavelength of light as being transmitted from the downstream transmitter, by limiting the wavelength to the predetermined band.

The wavelength band as being limited and passed by the band passing filter may be 5 nm to 10 nm.

The remote node may have an amplifier for amplifying the upstream optical signals as being transmitted from the optical network unit.

The central office may have a pump means for pumping the amplifier of the remote node.

The amplifier may be an Erbium-doped optical fiber (EDF).

The wavelength of light as being amplified in the amplifier by the pump means is a band of 1.5 μm.

The pump means may be a pump laser diode (Pump-LD).

### BRIEF DESCRIPTION OF THE DRAWINGS

The above aspects and features of the present invention will be more apparent by describing certain embodiments of the present invention with reference to the accompanying drawings, in which:

FIG. 1 is a constitutional block diagram of a general EPON;

FIG. 2 is a constitutional block diagram of a general WDM PON;

FIG. 3 is a constitutional block diagram of an optical network according to a first embodiment of the present invention;

FIG. 4 is a table comparing total costs of the general EPON and WDM PON systems;

FIG. 5 is a constitutional block diagram of an optical network according to a second embodiment of the present invention;

FIG. 6 is a constitutional block diagram of an optical network according to a third embodiment of the present invention; and

FIG. 7 is a constitutional block diagram of an optical network according to a fourth embodiment of the present invention.

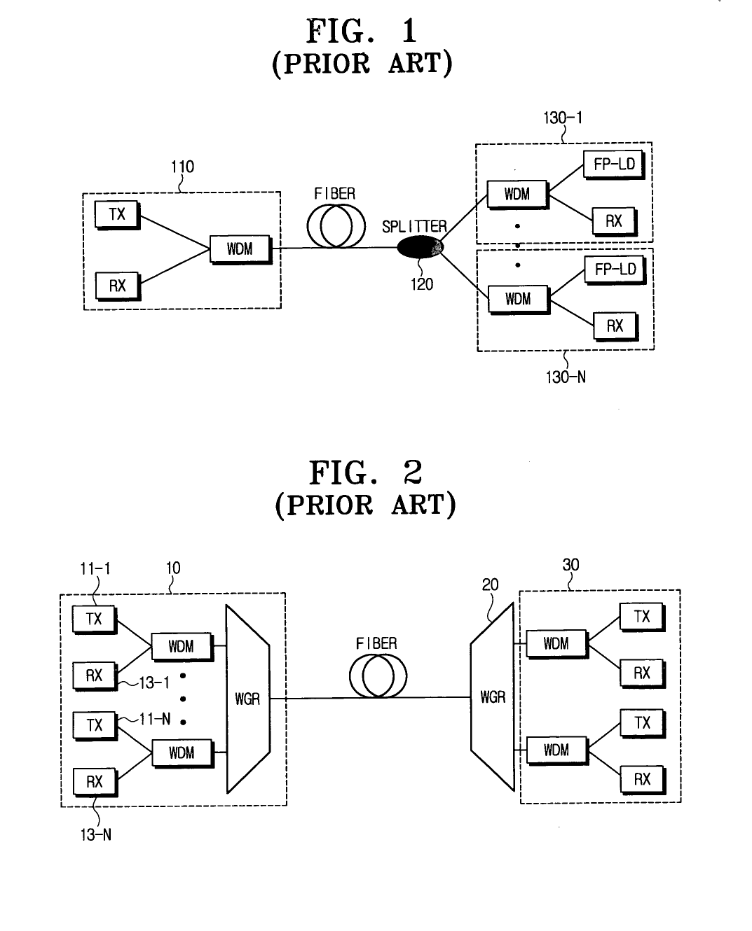

### DETAILED DESCRIPTION OF EXEMPLARY EMBODIMENTS

Embodiments of the present invention will be described in detail with reference to the included drawings below: Where the function and constitution are well-known in the relevant arts, further discussion will not be presented in the detailed description in order not to unnecessarily make the gist of the present invention unclear.

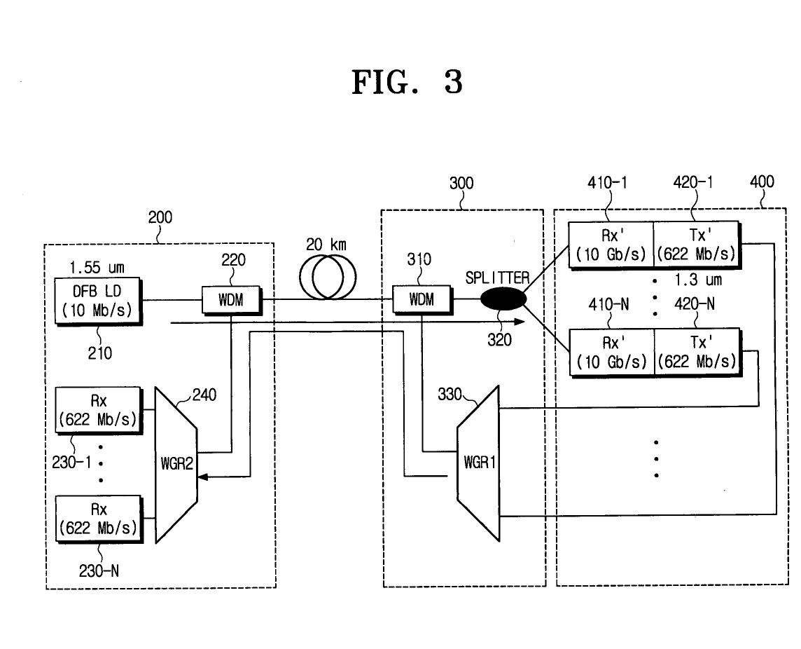

FIG. 3 is a constitutional block diagram of an optical network according to a first embodiment of the present invention.

With reference to FIG. 3, the optical network according to the present embodiment selects an EPON for the downstream wherein data is transmitted from an optical line termination (OLT) 200 to the direction of an optical network unit (ONU) 400 and uses a WDM PON for the upstream wherein the data is transmitted from the ONU 400 to the direction of the OLT 200.

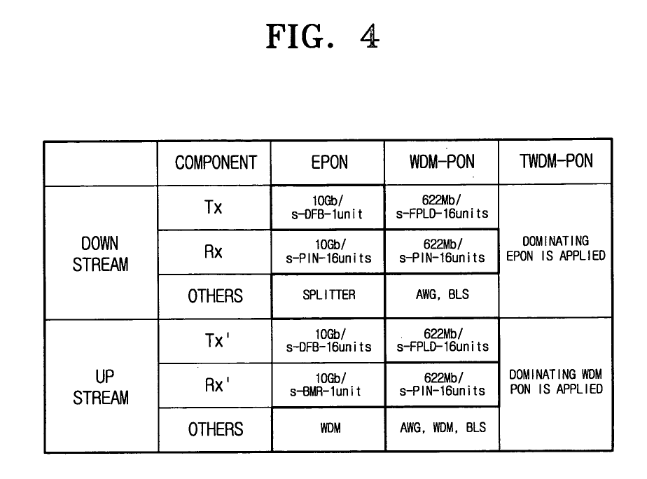

The reason why the different transmission systems are selected with respect to the downstream and the upstream, respectively, will be described in reference to the diagram as shown in FIG. 4, below:

In FIG. 4 comparing the respective total costs of the general EPON and WDM PON systems, the optical network will be described with respect to the downstream wherein the data is transmitted from the OLT 200 to the direction of the ONU 400.

A data transmission speed of an element for a light source used in a downstream transmitter 210 of the OLT 200 in the EPON is faster than that of the WDM PON. However, the number of elements for the light source in the EPON is less than that of the WDM PON. This means that, to use the light source in which the transmission speed is increased at a predetermined rate is more profitable in respect to the costs, rather than to increase the number of light sources to a predetermined number.

Although the elements which are used in the RX 230-1, . . . , 230-N are less expensive in the WDM PON than the EPON, the other optical elements used are less expensive in the EPON. Thus, the EPON system is selected in the downstream of the optical network according to the present invention.

Next, the upstream wherein data is transmitted from the ONU 400 to the direction of the OLT 200 will be described.

The number of elements for the light source used in Tx′ 420-1, . . . , 420-N of the ONU 400 is equal in the two systems. Thus, the WDM PON with the elements for the light source having the slow data transmission speed is profitable with respect to the costs. From this aspect, upon comparing the costs of the EPON system and the WDM PON system, the WDM PON is less expensive. Thus, the WDM PON system is selected for the upstream of the optical network according to the present invention.

In the EPON system used for the downstream as shown in FIG. 3, primarily one OLT 200 is connected by the tree structure of 1 to N by the ONU 400 and the optical distributor 320. The optical distributor 320 is located in the remote node 300.

Since the OLT 200 of the EPON is accessed to the Rx′ 410-1, . . . , 410-N of the ONU 400 in the time dimension, the single Tx 210 of the OLT 200 is used. That is, if the TX 210 of the OLT 200 transmits the signals to be transmitted at the same time, the Rx′ 410-1, . . . , 410-N of the ONU 400 receives a corresponding signal only.

The light source applied to the Tx 210 of the OLT 200 as shown in FIG. 3 is a distributed feedback laser diode (DFB-LD), and this uses the mechanism in which the DFB-LD oscillates in the wavelength of a specific part of the 1.3 μm band. As the data transmission speed of the DFB-LD is 10 Gb/s, the DFD-LD is received in a number of Rx′ 410-1, . . . , 410-N of the ONU 400 and is oscillated to each intrinsic wavelength band at the time dimension.

The downstream data frame transmitted from the OLT 200 is distributed to each of the Rx′ 410-1, . . . , 410-N of the ONU 400 and is connected with the optical distributor 320 for multiplexing the data by the time division multiplex system and transmitting the multiplexed data to the Rx′ 410-1, . . . , 410-N of the ONU 400. If the data transmitted to the Rx′ 410-1, . . . , 410-N of the OLT 200 is received, the connected optical distributor 320 equally distributes the data received in each of the Rx′ 410-1, . . . , 410-N of the ONU 400 and transmits the distributed data. From the data transmitted from the optical distributor 320, the ONU 400 detects the data to be transmitted to each user and transmits only the detected data to the user.

Next, the upstream of transmitting data from the ONU 400 of the optical network to the direction of the OLT 200 will be described below:

In the WDM PON system selected for the upstream as shown in FIG. 3, the Tx′ 420-1, . . . , 420-N of the ONU 400 and the Rx 230-1, . . . , 230-N of the OLT 200 are connected by the structure of N to N by a first router (WGR1) 330 and a second router (WGR2) 240.

The ONU 400 transmits a number of optical wavelength signals to the OLT 200 and mechanically distributes the wavelengths determined for the OLT 200 by the WGR1 330 and WGR2 240. Thus, a number of Rx 230-1, . . . , 230-N of the OLT 200 are used. Of the wavelengths distributed in this manner, each band as being transmitted is received in each of the Rx 230-1, . . . , 230-N.

The upstream wavelength from the ONU 400 to the direction of the OLT 200 is different from the downstream wavelength from the OLT 200 to the direction of the ONU 400, and the different wavelengths are multiplexed in the WGR1 330 and WGR2 240, respectively, and are transmitted to the OLT 200.

In the WDM PON system, each wavelength is oscillated with respect to one band only, so that a corresponding wavelength is accessed to each of the Rx 230-1, . . . , 230-N of the OLT 200. The WGR1 330 unites the wavelengths of a number of bands and outputs the united wavelength, and the WGR2 240 divides the united wavelength according to the bands and transmits the divided wavelength to each of the Rx 230-1, . . . , 230-N of the OLT 200.

That is, the WGR1 330 used with the ONU 400 multiplexes the channel signals, which are input in turn from the number of Tx′ 420-1, . . . , 420-N of the ONU 400, in one output terminal and outputs the multiplexed signals. The WGR2 240 used in the OLT 200 multiplexes the wavelength-division-multiplexed signals, which are input through one input terminal, in a number of output terminals and outputs the multiplexed signals.

The EPON system selected for the downstream according to the present invention uses the mechanism of multiplexing the optical signals in the time region, wherein power of the optical signals oscillating in the specific part are different with respect to each time dimension. The Rx′ 410-1, . . . , 410-N of the ONU 400 oscillating in the specific part are waved if the power of the received optical signals is different. That is, the Rx′ 410-1, . . . , 410-N of the ONU 400 oscillate with a uniform oscillating profile in a usual case, but if an optical signal with a different power is received, they oscillate with an unstable oscillating profile.

Here, to manufacture a burst mode receiver as a receiver for correcting the above-mentioned waving problem, i.e., for performing a burst operation, is an outstanding issue. However, if the WDM PON system is selected for the upstream as in the present invention, there is no occurrence of the aforementioned problem.

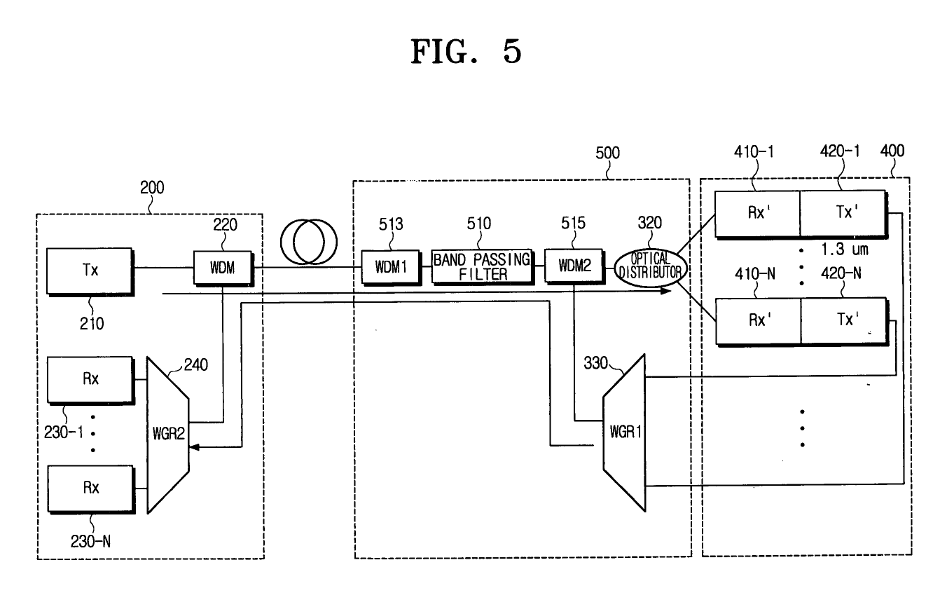

FIG. 5 is a constitutional block diagram of an optical network of a second embodiment of the present invention. As for the optical elements of the second embodiment, which have the same names and functions as in FIG. 3, further description will not be presented.

In FIG. 5, it is specified that, in the EPON system applied for the downstream data transmission mode, the Tx 210 for downstream is the Fabry-Perot laser diode (FP-LD).

The FP-LD outputs multiple wavelengths which are positioned at regular wavelength intervals around one wavelength according to the characteristics of the known wavelength of the laser diode and the cost of the manufacturing materials. In the case of using the FP-LD as the light source, a problem occurs by chromatic dispersion resulting from the broad bandwidth. To solve this problem, a band passing filter 510 is provided in the remote node 500.

The band passing filter 510 limits the wavelength band by minimizing the chromatic dispersion caused by the FP-LD and simultaneously minimizing a mode partition noise occurring among the wavelengths of a number of bands.

The bandwidth is not to be affected by the mode partition noise and the chromatic dispersion is 5 nm to 10 nm.

Consequently, if the wavelength of the bandwidth being 5 nm to 10 nm is filtered by the band passing filter 510, it is possible to transmit data for a 20 km or further distance, without any influence of the chromatic dispersion of the optical fiber and the noise of various kinds.

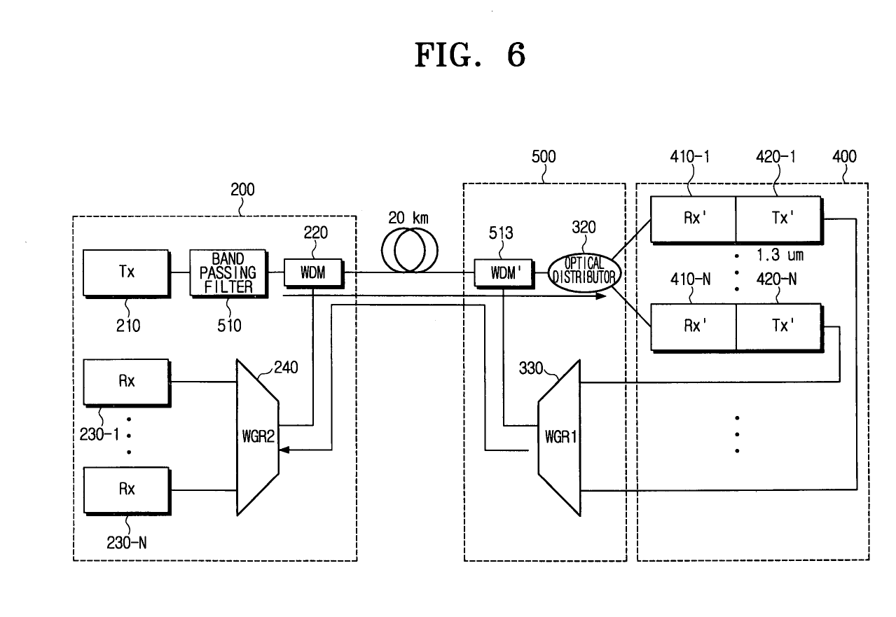

FIG. 6 is a constitutional block diagram of an optical network according to a third embodiment of the present invention. As for the optical elements of the third embodiment, which have the same names and functions as in FIG. 3, further description will not be presented.

In FIG. 6, the OLT 200 for the downstream according to the third embodiment comprises a band passing filter 510 between the WDM 220 and one Tx 210 of the OLT 200.

The band passing filter 510 is arranged at the OLT 200, differently from the second embodiment of the present invention, and the function of the band passing filter 510 is to filter the optical signals to limit the bandwidth to a predetermined bandwidth in order to solve the problems such as the chromatic dispersion caused by the broad bandwidth of the FP-LD as discussed with respect to the second embodiment.

The range of the bandwidth as being limited by the band passing filter 510 and the acting effects thereof are same.

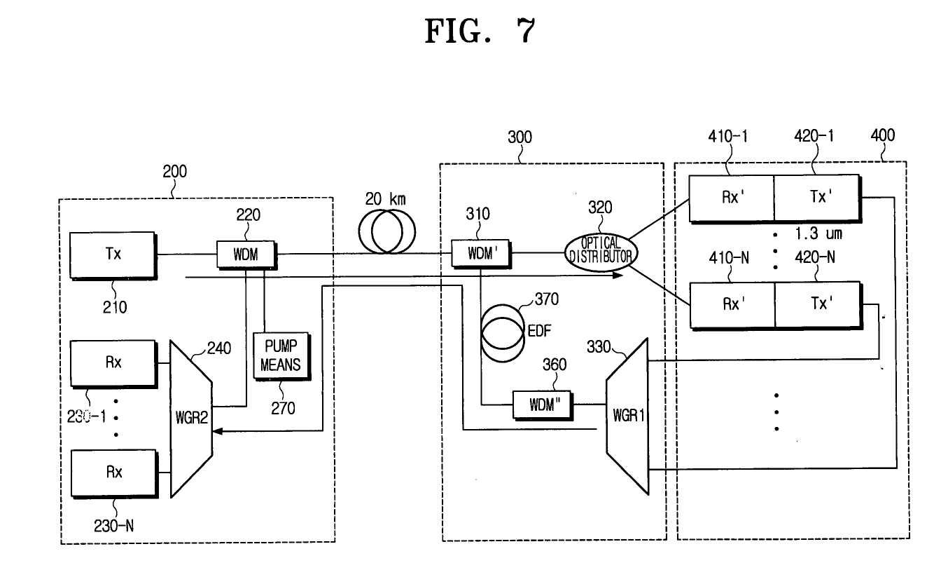

FIG. 7 is a constitutional block diagram of an optical network according to a fourth embodiment of the present invention. As for the optical elements of the fourth embodiment having the same names and functions as in FIG. 3, further description will not be presented.

In FIG. 7, it is specified that, in the WDM-PON system applied for the upstream data transmission mode, a light emitting diode (LED) is used for the Tx′ 420-1, . . . , 420-N for the upstream.

The LED is the light source having a number of wavelengths oscillating at the same time, wherein only one band is selected. This technique is the WDM PON system.

In the general WDM PON system, the LED is not selected as the light source for the upstream. However, in the fourth embodiment of the present invention, a pump means 270 is used in the OLT 200, thereby amplifying the output of the LED.

The LED is the light source oscillating the wavelengths of a number of bands, wherein the WGR2 240 divides the wavelengths according to bands. Even though the wavelength of a broad band by the LED is oscillated, only the band corresponding to an intrinsic wavelength is output due to the characteristics of the WGR2 240.

It is possible to perform the WDM PON system by using the characteristics of the WGR2 240 even though the LED is selected as the upstream Tx′ 420-1, . . . , 420-N as in the fourth embodiment. However, since the output power of the LED is too low, it is necessary to solve that problem. Such low output power makes it impossible to perform a long distance transmission and to increase the data transmission speed.

In order to solve the problem of the low output power of the LED, the fourth embodiment uses the pump means 270. As the pump means 270 is applied in the OLT 200, the LED can be selected as the light source for the high-speed transmission of data. A pump laser diode is used as the pump means 270, wherein an erbium-doped fiber (EDF), which will be described later, is used as an amplifier to amplify the output power of the LED.

The EDF 370 as the amplifier is a kind of a passive element, which can be amplified in 1.5 μm as the wavelength band to be used in the optical communication, by doping erbium. The amplification of the EDF 370 is possible in the aforementioned band since the pump means 270 is used in the OLT 200 as described above. As the pump means 270 oscillates in the wavelength band of 0.98 μm, the amplification of 0.98 μm is performed, thereby making it possible to use the LED as the light source for the optical network.

The fourth embodiment according to the present invention uses the LED as the light source of the upstream, by the remote pumping technique that additionally uses the pump means 270 in the OLT 200.

As described above, according to the time and wavelength division multiplexed passive optical network of the present invention, the time division multiplex system is used for the downstream transmission of data and the wavelength division multiplex system is used for the upstream transmission, thereby resulting in the total cost reduction.

In addition, since each of the time division multiplex system and the wavelength division multiplex system makes up for its own defects, use of the two systems results in an advantage of transmitting high quality optical signals.

The foregoing embodiments and advantages are merely exemplary and are not to be construed as limiting the present invention. The present teaching can be readily applied to other types of apparatuses. Also, the description of the embodiments of the present invention is intended to be illustrative, and not to limit the scope of the claims, and many alternatives, modifications, and variations will be apparent to those skilled in the art.

What is claimed is:

1. A time and wavelength division multiplexed passive optical network comprising:
a central office having a downstream transmitter and at least one upstream receiver, wherein the downstream transmitter multiplexes downstream optical signals in a time region and transmits the multiplexed signals, and wherein the upstream receiver de-multiplexes, in a wavelength region, at least one upstream optical signal which is multiplexed in the wavelength region and transmitted, thereby the central office receives the de-multiplexed signal;
an optical network unit (ONU) having a downstream receiver and an upstream transmitter, wherein the downstream receiver de-multiplexes, in the time region, the downstream optical signals which are multiplexed in the time region and transmitted from the central office, thereby the optical network unit receives the de-multiplexed signals, and wherein the upstream transmitter multiplexes the upstream optical signal in the wavelength region and transmits the multiplexed signal to the central office; and
a remote node having an optical distributor and a wavelength division multiplexer, wherein the remote node is connected between the central office and the optical network unit, the optical distributor distributes, to each optical network unit, the downstream optical signals which are multiplexed in the time region and transmitted from the central office, and the wavelength division multiplexer multiplexes, in the wavelength region, the upstream optical signal which is transmitted from each optical network unit.

2. The optical network as claimed in claim 1, wherein the remote node comprises a first router configured to multiplex, in a wavelength band, each optical signal which is transmitted from at least one optical network unit.

3. The optical network as claimed in claim 1, wherein the central office comprises a second router for de-multiplexing, in the wavelength region, the upstream optical signal which is transmitted from the optical network unit.

4. The optical network as claimed in claim 1, wherein the downstream optical signal operates in a wavelength band of 1.3 μm.

5. The optical network as claimed in claim 1, wherein the upstream optical signal operates in a wavelength band of 1.5 μm.

6. The optical network as claimed in claim 1, wherein the remote node comprises a band passing filter configured to pass a wavelength of light transmitted from the downstream transmitter by limiting the wavelength to a predetermined band.

7. The optical network as claimed in claim 1, wherein the central office comprises a band passing filter configured to pass the wavelength of light transmitted from the downstream transmitter by limiting the wavelength to the predetermined band.

8. The optical network as claimed in claim 6, wherein the wavelength band being limited and passed by the band passing filter is 5 nm to 10 nm.

9. The optical network as claimed in claim 1, wherein the remote node comprises an amplifier in which the upstream optical signals being transmitted from the optical network unit are amplified.

10. The optical network as claimed in claim 9, wherein the central office comprises a pump means for pumping the amplifier of the remote node.

11. The optical network as claimed in claim 9, wherein the amplifier is an erbium-doped fiber.

12. The optical network as claimed in claim 10, wherein the wavelength of light being amplified in the amplifier by the pump means is a band of 1.5 μm.

13. The optical network as claimed in claim 10, wherein the pump means is a pump laser diode (Pump-LD).
